(19) United States
(12) Patent Application Publication
(10) Pub. No.: US 2003/0184152 A1
(43) Pub. Date: Oct. 2, 2003

(54) Regenerative braking system for a hybrid electric vehicle

(75) Inventors: Susan Rebecca Cikanek, Wixom, MI (US); Kathleen Ellen Bailey, Dearborn, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(73) Assignee: Ford Motor Company, Dearborn, MI (US)

(21) Appl. No.: 10/063,143

(22) Filed: Mar. 25, 2002

(51) Int. Cl. B60T 8/64

(52) U.S. Cl. 303/152

(57) ABSTRACT

A regenerative braking system for use with a hybrid electric vehicle 10 including an internal combustion engine 14, an electric motor/generator or transaxle assembly 16, and a transmission assembly 18 which selectively receives torque from the engine 14 and transaxle 16 and delivers the received torque to vehicle's wheels 26, 28. The engine 14 is connected to the transmission assembly 16 by use of a clutch 20. During regenerative braking events, the system automatically disengages clutch 20, thereby allowing a maximum amount of energy to be recovered by the transaxle assembly 16, as engine “drag” is eliminated. Furthermore, the system disengages clutch 20 during idling conditions, and utilizes transaxle 16 to provide a negative torque to the driveline, effective to recover energy and to simulate engine drag forces due to compression braking effects, thereby providing a driver of the vehicle 10 with consistent feel during all operating modes.

### BACKGROUND OF INVENTION

(1) Field of the Invention

The present invention relates to a regenerative braking system for a hybrid electric vehicle, and more particularly, to a regenerative braking system for a hybrid electric vehicle which provides improved efficiency and fuel economy benefits.

(2) Background of the Invention

An automobile consists of the integration of many complex nonlinear systems, one of which is the powertrain system. A conventional vehicle powertrain consists of a powerplant, transmission and driveline including a differential and axle system which rotatably drive the front and/or rear wheels of the vehicle. Furthermore, various accessories and peripherals are connected to the powerplant such as power steering, power brakes, and air conditioning systems. The vehicle powertrain is a composition of electrical, mechanical, chemical, and thermodynamic devices connected as a nonlinear dynamic integrated system, with the primary objective of providing the power source for transportation.

One type of vehicle, commonly referred to as a hybrid electric vehicle (“HEV”), combines an electric vehicle (“EV”) powertrain system with conventional powertrain components, such as an internal combustion engine. A parallel hybrid electric vehicle (“PHEV”) includes an electric motor powertrain system and a conventional powertrain system that provide power to the drive wheels simultaneously.

One of the advantages of an HEV is provided by its source of electrical power (e.g., its batteries), which can extend the range and performance of the HEV. By combining an auxiliary powerplant, such as an internal combustion engine/alternator combination, with a conventional EV powertrain, an HEV can potentially extend the vehicle performance envelope and fuel economy, while reducing emissions relative to a conventional internal combustion engine powertrain.

Most HEVs employ both a conventional (e.g., hydraulic or friction) braking system and a regenerative braking system. The conventional braking system typically includes several frictional drum or disc type braking assemblies which are selectively actuated by a hydraulic system. A control system modulates the hydraulic pressure applied to the frictional braking assemblies in a manner which controls the slippage of the vehicle's wheels relative to the road surface. The regenerative braking system within these vehicles utilizes the vehicle's electric motor to provide a negative torque to the driven wheels and converts the vehicle's kinetic energy to electrical energy for recharging the vehicle battery or power supply.

The present invention provides a new and improved regenerative braking system for a hybrid electric vehicle that provides improved performance, efficiency and reliability at no additional cost.

### SUMMARY OF INVENTION

A first non-limiting advantage of the invention is that it provides a new and improved regenerative braking system for use with a parallel type hybrid electric vehicle.

A second non-limiting advantage of the invention is that it provides a new and improved regenerative braking system that maximizes the regenerative braking force of a hybrid electric vehicle based upon various vehicle attributes.

A third non-limiting advantage of the invention is that it utilizes a control strategy which selects a proportioning gain that satisfies all design goals (e.g., stopping distance, front lock up), while maximizing the percentage of regenerative braking performed by the vehicle.

A fourth non-limiting advantage of the invention is that it reduces negative regenerative torque linearly at low vehicle speeds where minimal energy can be recovered.

A fifth non-limiting advantage of the invention is that it provides regenerative braking torque during electric drive modes, effective to simulate engine compression braking, thereby giving the vehicle a more consistent feel.

A sixth non-limiting advantage of the present invention is that it disengages the engine clutch during regenerative braking events, effective to maximize energy recovery.

According to a first aspect of the present invention, a braking system is provided for use within a hybrid electric vehicle. The braking system includes a driveline which selectively and rotatably drives a pair of wheels of the vehicle; an engine which selectively provides a first torque to the driveline; a first clutch which selectively disconnects the engine from the driveline; a transaxle assembly which selectively provides a negative torque to the driveline effective to recover energy during certain braking events; and a control system which controls the first clutch and which selectively disengages the first clutch during the certain braking events, effective to disconnect the engine from the driveline during the certain braking events, thereby increasing the recovered energy.

According to a second aspect of the present invention, a method is provided for regenerative braking within a vehicle including an engine and a transaxle assembly which are selectively connected to a driveline. The method includes the steps of: sensing a braking event; causing the transaxle to provide a regenerative torque to the driveline, effective to generate an amount of energy; and selectively disconnecting the engine from the driveline during the braking event, effective to increase the amount of energy generated during the braking event.

These and other features, aspects, and advantages of the invention will become apparent by reading the following specification and by reference to the following drawings.

### BRIEF DESCRIPTION OF DRAWINGS

FIG. 1 is a schematic view of a hybrid electric vehicle having a regenerative braking system which is made in accordance with the teachings of a preferred embodiment of the present invention.

FIG. 2 is a block diagram of a control system which implements the regenerative braking strategy of the present invention.

FIG. 3 is a graph illustrating front and rear brake “lockup” characteristics.

FIG. 4 is a graph of master cylinder pressure versus vehicle deceleration.

FIG. 5 is a graph of master cylinder pressure versus motor torque which is used by the regenerative braking system of the present invention to determine the regenerative braking force to apply to the vehicle's driveline during braking events.

FIG. 6 is a block diagram illustrating the general functionality of the control system employed within the present invention.

FIG. 7 shows several graphs illustrating various vehicle characteristics during a simulation of the present invention with a low acceleration/deceleration profile in a 10% grade hybrid operation.

FIG. 8 shows several graphs illustrating various vehicle characteristics during a simulation of the present invention with a low acceleration/deceleration profile in hybrid operation.

### DETAILED DESCRIPTION

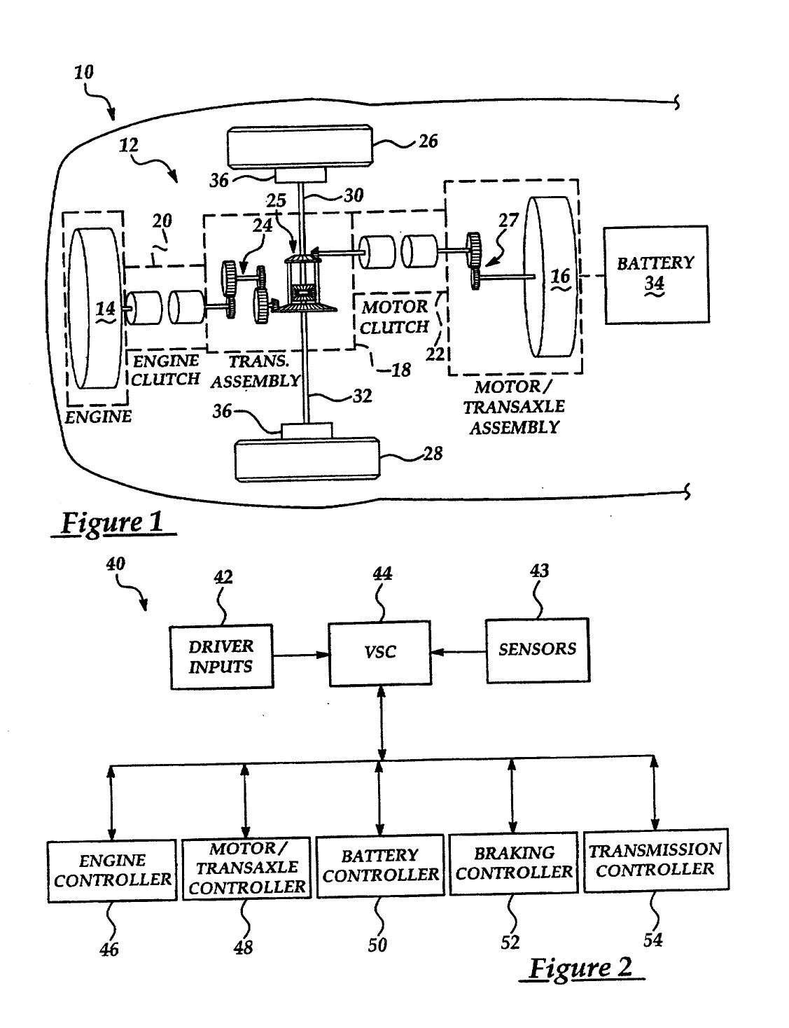

Referring now to FIG. 1, there is shown an automotive hybrid electric vehicle 10 having a powertrain, propulsion or drive system 12 which employs a regenerative braking system made in accordance with the teachings of the preferred embodiment of the present invention. As should be appreciated to those of ordinary skill in the art, propulsion system 12 is a parallel type propulsion system, and includes an internal combustion engine 14, an electric motor/generator or transaxle assembly 16, and a transmission assembly 18.

The engine 14 and transmission assembly 18 are selectively interconnected by use of an engine clutch 20, and the transaxle or traction motor assembly 16 is selectively interconnected to the transmission assembly 18 by use of a motor clutch 22. Transmission assembly 18 includes a plurality of gears 24, and a differential mechanism 25 which selectively receives torque from the engine 14 and motor/transaxle 16 and transfers the received torque to axle shafts 30, 32, thereby driving wheels 26, 28. In the preferred embodiment of the invention, wheels 26, 28 are the front wheels of vehicle 10.

In the preferred embodiment of the invention, the engine 14 is a conventional internal combustion engine, and is physically and operatively coupled to the vehicle's “driveline” (e.g., the transmission, differential 25 and shafts 30, 32) through clutch 20 and gears 24. Transaxle 16 is a conventional motor/generator and is physically and operatively coupled to the driveline through gears 27 and clutch 22. Transmission assembly 18 allows engine 14 and transaxle 16 to cooperate as a “single power source” which provides a single power or torque output the vehicle's driveline for driveably turning axles 32, 32 and wheels 26, 28. Furthermore, clutches 20, 22 allow engine 14 and transaxle 16 to be selectively and independently connected and disconnected from the vehicle's driveline. In this manner, the two power sources (i.e., the internal combustion engine and transaxle) may cooperatively deliver torque and power to the vehicle 10 simultaneously and/or independently. It should be appreciated that the schematic illustration of vehicle 10 and propulsion system 12 has been simplified for purposes of this discussion and that vehicle 10 may include additional and/or alternate gearing assemblies and other components which are not critical to the present discussion.

A conventional and selectively rechargeable electrical energy storage device 34 (e.g., a battery or other electrical energy storage device) is operatively coupled to transaxle or motor/generator 16. Battery 34 provides power to motor/generator 16 and receives power from motor/generator 16 during regenerative braking events. Vehicle 10 further includes conventional friction brakes 36 which are operatively coupled to each of the vehicle's front and rear wheels, and which are actuated in a conventional manner, such as by use of a conventional hydraulic system (not shown).

Referring now to FIG. 2, there is illustrated a non-limiting example of a hierarchical control system 40 which may be employed within vehicle 10. In the preferred embodiment of the invention, a central or vehicle system controller (“VSC”) 44 is electrically and communicatively coupled to conventional user or driver operated controls or components 42 and to one or more conventional vehicle operating condition sensors 43. As described more fully and completely below, controller 44 receives signals and/or commands generated by driver inputs 42, vehicle operating condition sensors 43, and subsystem feedback, and processes and utilizes the received signals to determine the amount of torque which is to be provided to the vehicle's driveline, to optimize the vehicle's regenerative braking function, and to generate commands to the appropriate subsystems or controllers 46 54 to selectively provide the desired torque to wheels 26, 28.

In the preferred embodiment, each subsystem 46 54 includes one or more microprocessors or controllers as well as other chips and integrated circuits which cooperatively control the operation of propulsion system 12. In the preferred embodiment, controller 46 comprises a conventional engine controller which is operatively coupled to and controls the operation of engine 14, controller 48 comprises a conventional motor/transaxle controller which is operatively coupled to and controls the operation of motor/transaxle 16, controller 50 comprises a conventional battery controller which is operatively coupled to and controls the operation of battery 34, controller 52 comprises a conventional braking controller which controls the hydraulic braking system, and controller 54 is a conventional transmission controller which controls the operation of transmission assembly 18 and the engagement/disengagement of clutches 20, 22. It should be appreciated that control system 40 may include additional controllers to control other vehicle components and subsystems. It should further be appreciated that controllers 44 54 may each comprise a separate controller or may be embodied within a single controller, chip, microprocessor or device. Controller 44 is effective to determine the total amount of torque which is to be provided or delivered to driveline and to partition or divide the total amount of torque between the various subsystems or components (e.g., between the engine 14 and transaxle assembly 16). In the control system architecture 40, the VSC 44 is typically the “superior” controller, with subsystems 46 54 acting as subordinate controllers.

The coordinated VSC controller 44 provides motoring and regenerative commands to the motor or transaxle controller 48 for corresponding positive and negative motor torque, throttle commands to the engine controller 46, and clutch engagement/disengagement commands to transmission controller 54. These commands are based on the battery state of charge (“SOC”), motor speed versus torque limits, motor torque current, motor field current, transmission gear, driver accelerator pedal position, brake pedal, engine clutch state, motor clutch state, engine speed, average power at the drive wheels, shift status, estimated engine torque, and estimated engine torque available. In addition, the controller 44 provides clutch control during braking, or hybrid operation.

The torque may be partitioned to operate in an engine only mode, a motor only mode, or a two traction device mode (i.e., “hybrid mode”). The engine only mode supplies no regenerative braking. Hybrid mode operation consists of motor only operation, engine operation, motor torque application during shifting, motor assist during power boost, and regenerative braking. The propulsion system 12 will provide negative torque by use of the transaxle 16 during regenerative braking for energy recovery.

The controller 44 coordinates with the vehicle subsystems 46-54 to provide an improved regenerative braking function which maximizes the amount of energy generated or recovered based upon various vehicle operating attributes and driver commands.

The present control system 40 applies regenerative braking torque upon brake pedal application, to the driven wheels, in addition to hydraulic braking torque provided by the friction brakes 38. The control system 40 further provides simulated compression braking by use of the electric motor or transaxle 16 which gives the driver the feeling of engine drag present in an internal combustion engine vehicle while advantageously recovering kinetic energy, and is used as part of the regenerative braking strategy.

Hydraulic brake torque is commanded by application of the brake pedal from the driver, which is measured as a value of master cylinder pressure. Regenerative brake commands are predetermined, in a manner which is described more fully and completely below, as a function of master cylinder pressure and are based on VSC coordinated control inputs. The transaxle assembly 16 and controllers 48, 50 then provide power to the battery 34, and negative torque to the driveline, which in turn brakes the vehicle.

The regenerative brake torque added to the hydraulic brake torque in the present system is predetermined as a function of the master cylinder pressure, and is stored within tables or matrices resident within controller 44. The following calculations determine the relationship between electric brake torque and hydraulic brake pressure:

$${T}_{e} = [ \frac{( {g}^{′} s \cdot {R}_{w} \cdot {W}_{v} ) - ( 2 \cdot {BF}_{f} \cdot {P}_{f} ) - ( 2 \cdot {BF}_{r} \cdot {P}_{r} )}{{g}_{4 \times 4} \cdot {g}_{axle}} ] \qquad ( Eq . 1 )$$

where g's is a unitless parameter representing vehicle acceleration/deceleration due to gravity; R_{w} is the vehicle's wheel radius in ft; Wᵥ is vehicle weight in lbf; BF_{f′} BFᵣ are the front and rear brake factors, respectively, in lbf-ft/psi; P_{f} is the front brake pressure in psi; Pᵣ is the rear brake pressure in psi; gₐₓₗₑ is the transaxle gear ratio; and g_{4×4} is the 4×4 or differential gear ratio.

The front and rear brake pressure is a function of the sensed master cylinder pressure and is determined as follows:

P_{f}−P_{mc} (Eq. 2)

Pᵣ=P_{mc} for P_{mc}≦X (Eq. 3)

Pᵣ=X+δ(P_{mc}−X) for P_{mc}>X (Eq. 4)

where P_{mc} is the master cylinder pressure in psi; X is the master cylinder pressure at which brake proportioning changes in psi; and δ is a brake proportioning coefficient.

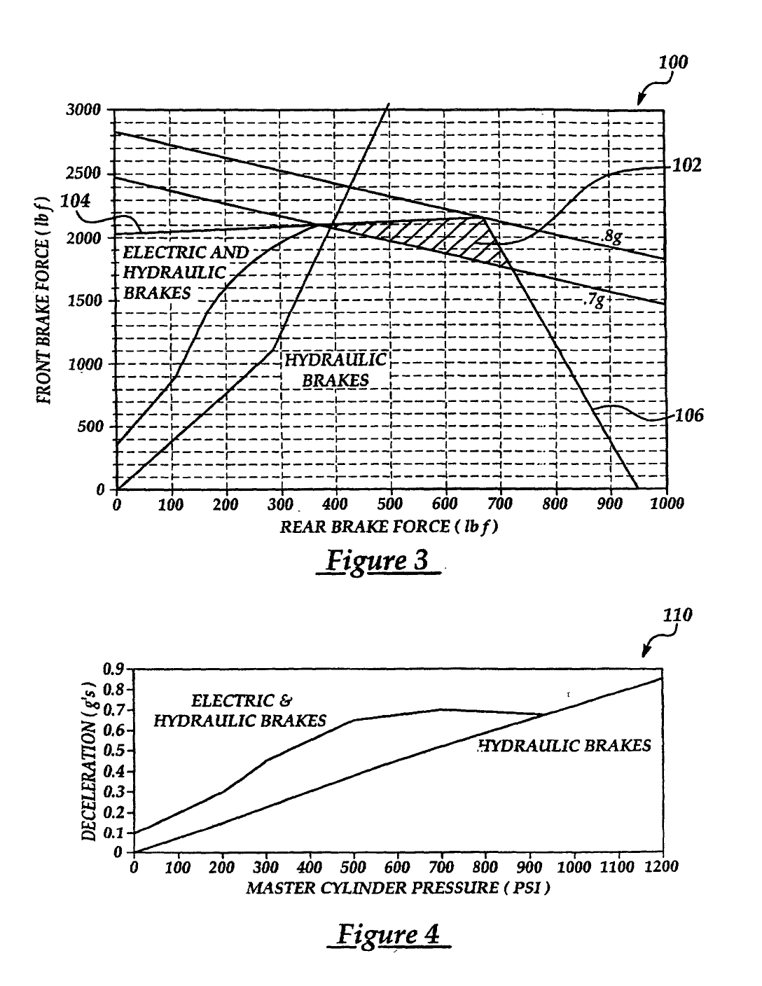

The amount of electric brake torque that can be added to the hydraulic brake torque is shown in graph 100 of FIG. 3 and is a function of static brake force relationships, motor torque characteristics, driver feel, and the tire/road surface interface.

Static brake force relationships are programmed and/or saved within the memory of controller 44 and are determined by plotting a static brake force graph that includes front and rear brake “lockup” characteristics for several road surfaces, front and rear brake proportioning relationships, and vehicle deceleration. The front and rear brake “lockup” curves (i.e., curves 104, 106 of graph 100) represent the maximum force that the front and rear brakes can deliver to the road surface without the front and rear brakes experiencing “lockup” for various road surfaces. Brake forces applied above lockup curves 104, 106 results in lockup on the corresponding front or rear axle. One non-limiting example of front and rear brake “lockup” characteristics, plotted as front versus rear brake forces, is shown in graph 100 of FIG. 3.

The vertical axis of graph 100 represents the front brake force and the horizontal axis represents the rear brake force. The slopes and intercepts for the maximum front and rear brake forces, as shown in graph 100, are as follows:

$$\begin{matrix}{F}_{max f} = \frac{{μ}_{p} ( {W}_{v} B / L )}{1 - {μ}_{p} I I / L} & ( Eq . 5 ) \\ {F}_{max r} = \frac{{μ}_{p} ( {W}_{v} A / L )}{1 + {μ}_{p} I I / L} & ( Eq . 6 ) \\ {slope}_{f max} = \frac{{μ}_{p} H / L}{1 - {μ}_{p} H / L} & ( Eq . 7 ) \\ {slope}_{r max} = \frac{- {μ}_{p} H / L}{1 + {μ}_{p} H / L} & ( Eq . 8 )\end{matrix}$$

where F_{maxf}, Fₘₐₓᵣ are the maximum front and rear brake force y-axis intercepts, respectively, in lbf; slope_{fmax}, slopeᵣₘₐₓ are the maximum front and rear brake force slopes, respectively; μₚ is the peak coefficient of friction of the road surface; A is the distance from the vehicle's center of gravity to the front axle, in ft; B is the distance from the vehicle's center of gravity to the rear axle, in ft; H is the height of the vehicle's center of gravity, in ft; and L is the vehicle's wheelbase, in ft.

The front and rear brake forces are related to the brake pressure, as shown in the following relationships:

$$\begin{matrix}{F}_{rear} = \frac{2 \cdot {BF}_{r} \cdot {P}_{r}}{{R}_{w}} & ( Eq . 9 ) \\ {F}_{front} = \frac{2 \cdot {BF}_{f} \cdot {P}_{f}}{{R}_{w}} & ( Eq . 10 )\end{matrix}$$

where F_{front}, Fᵣₑₐᵣ are the front and rear brake forces, respectively, in lbf.

Vehicle deceleration, in “g's,” is plotted as a function of the total brake force, which is the sum of front and rear brake forces divided by the vehicle weight as shown by the following equation:

$${F}_{t} = {F}_{front} + {F}_{rear} = ( \frac{{W}_{v}}{g} ) {a}_{x} \qquad ( Eq . 11 )$$

where aₓ is the acceleration/deceleration of the vehicle in ft/sec², and where g is the universal gravitational constant (aₓ/g yields the vehicle acceleration/deceleration in “g's”).

Using the example illustrated in graph 100, if a deceleration rate of 0.7 g's is requested by the driver on a 0.85μ (road surface/tire adhesion coefficient) road surface, then any combination of front and rear brake force would satisfy the drivers request, while maintaining vehicle stability, as long as it exists in the triangle 102 shown in graph 100 bounded by the deceleration line and the front maximum brake force or “lock-up” line 104, and the rear maximum brake force “lock-up” line 106 for the 0.85μ road surface.

The controller 44 optimizes the regenerative braking function of vehicle 10 by selecting a proportioning ratio that will satisfy all of the design goals (stopping distance, front lockup first), allowing the total brake force to fall in the desired bounded triangle 102, while maximizing the percentage of braking performed on the axle that does regenerative braking.

The additional force that can be added to the front hydraulic brakes is determined from the static brake graph and a pressure versus vehicle deceleration graph 110 shown in FIG. 4.

The pressure versus deceleration graph 110 is used to determine the relationship between the electric torque added to the friction braking system and the road surface. The foundation brake curve is plotted as a function of pressure versus vehicle deceleration in g's as shown in the following equation:

$$decel = \frac{2 \cdot {BF}_{f} \cdot {P}_{f} + 2 \cdot {BF}_{r} \cdot {P}_{r}}{{W}_{v} \cdot {R}_{w}} \qquad ( Eq . 12 )$$

The road surface limit is chosen as 0.7, because according to the static brake graph this vehicle can attain a 0.7 g stop on a 0.85μ road/tire surface adhesion without lockup. A brake force application higher than 0.7 g may cause premature lockup and thus prevent energy recovery. Another limit that determines the electric braking is driver feel (e.g., simulated compression braking occurs at zero brake pressure).

For example, a “normal” brake stop that a driver commands approaching a red traffic light is approximately 0.2 g. At 100 psi, 0.2 g is plotted as an upper bound that a driver would accept for a relatively “light” brake pressure application. The driver feel curve is completed by allowing greater electric braking torque to be added at greater vehicle deceleration rates. The electric motor torque is determined using the foregoing relationships and the following equation:

$${T}_{e} = [ \frac{{g}^{′} {sW}_{v} {R}_{w} - 2 {P}_{f} {BF}_{f} - 2 {P}_{r} {BF}_{r}}{{g}_{4 \times 4} \cdot {g}_{axle}} ] \qquad ( Eq . 13 )$$

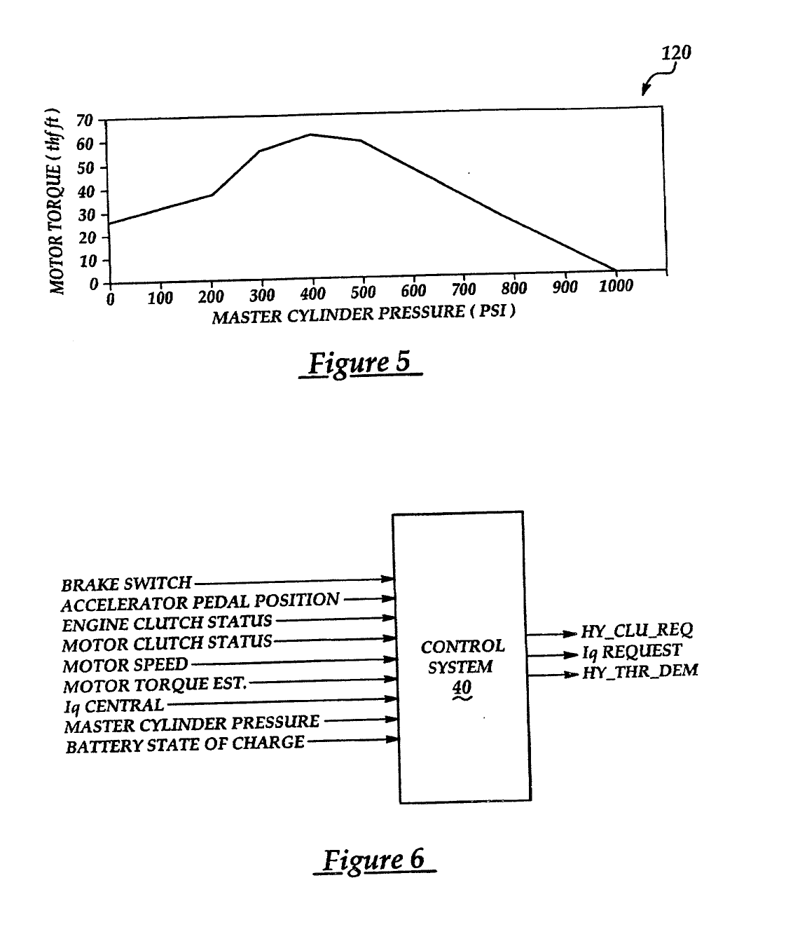

The electric motor torque can then be converted to force at the wheels, added to the front hydraulic brake force, and plotted against the rear brake force on the static brake force graph. Finally, motor torque as a function of master cylinder pressure can be plotted as shown in graph 120 FIG. 5.

It should be appreciated that the foregoing calculations may be performed prior to the programming of controller 44 using various “calibrated” or predetermined values (i.e., values established through controlled testing and/or experimentation), and the resulting calculated values and/or relationships may be stored within a plurality of tables or matrices within the controller 44, in order to preserve memory within controller 44. In this manner, controller 44 can determine the requisite and optimal regenerative brake forces by indexing various tables or matrices, rather than by continuously performing numerous calculations, thereby preserving memory.

The transaxle controller 48 provides positive and negative torque commands to the transaxle assembly 16 within the torque versus speed envelope of the motor. The magnitude of positive motor torque available is determined as a function of motor speed versus torque as follows:

$${T}_{available} = \frac{{P}_{rated}}{{ω}_{m}} \cdot 5252 , {ω}_{m} > {ω}_{b} \qquad ( Eq . 14 )$$

T_{available}=T_{rated} , ωₘ≦ω_{b} (Eq. 15)

where T_{available} is the positive motor torque available, in lbf-ft; P_{rated} is the rated motor power, in hp; ωₘ is the mechanical motor speed, in rpm; ω_{b} is the motor base speed, in rpm; and T_{rated} is the rated motor torque, in lbf-ft.

The magnitude of regenerative braking torque available is determined as a function of motor speed versus torque:

$$\begin{matrix}{T}_{regenavail} = \frac{{P}_{rated} \cdot 5252}{{ω}_{m}} - {T}_{compression} , {ω}_{m} > {ω}_{o} & ( Eq . 16 ) \\ {T}_{regenavail} = {T}_{rated} - {T}_{compression} , {ω}_{m} \leq {ω}_{b} & ( Eq . 17 )\end{matrix}$$

where T_{regenavail} is the motor torque available for regeneration, in lbf-ft; and T_{compression} is the compression braking torque, in lbf-ft.

The VSC coordinated controller 44 will determine the amount of positive and negative torque to be commanded to the motor and will communicate this value to controller 48.

Importantly, controller 44 reduces regenerative/negative motor torque that is linearly at low vehicle speeds where little or no energy can be recovered.

Furthermore, controller 44 commands simulated compression braking torque that allows for the recovery of energy, while concomitantly providing a consistent feel to the driver during certain driving conditions. Particularly, simulated compression braking is performed during hybrid and electric drive modes, when engine 14 is “idling” and/or when the driver is not applying pressure to the accelerator pedal or brake pedal. If the battery state-of-charge is full and simulated compression braking cannot be performed with the motor 16, compression braking is performed and/or generated by the engine 14 (i.e., clutch 22 is disengaged and clutch 20 is engaged). In order to perform this simulated compression braking, control system 40 disengages clutch 20, thereby disconnecting the engine 16 from the driveline. This eliminates the natural “drag” or negative torque that is caused by compression within the engine. In order to recreate or simulate this “drag” to provide the driver with a consistent “feel”, while simultaneously recovering energy, controller 44 activates the motor to provide a negative regenerative torque to the driveline. The amount of negative torque provided by this simulated compression braking is equivalent to that which the engine can provide under similar vehicle operating conditions. This is necessary to make the compression braking torque feel the same whether being performed by the engine, if the energy storage device is too full to except regenerative energy, or by the traction motor or transaxle assembly 16. Compression braking torque is determined as follows:

$${T}_{compression} - \frac{{g}^{′} s \cdot {R}_{w} \cdot {W}_{v}}{{g}_{4 \times 4} \cdot {g}_{axle}} \qquad ( Eq . 18 )$$

The torque delivered by the traction motor or transaxle assembly 16 is a function of motor and inverter dynamics, nonlinearities, and losses in both the motor and inverter as a function of motor speed. The traction motor torque limit is characterized as follows:

$${T}_{m} = \frac{{P}_{rated} \cdot 5252}{{ω}_{m}} {ω}_{m} > {ω}_{b} \qquad ( Eq . 19 )$$

Tₘ=T_{rated} ωₘ≦ω_{b} (Eq. 20)

(Tₑ−Tₘ)·1.3558=Jₘ\dot{ω}ᵣ (Eq. 21)

where Jₘ is motor inertia, in kg·m²; Tₘ is mechanical motor torque, in lbf-ft; and ^{\dot{ω}}^{ᵣ} is rotor acceleration, in rps².

The inverter load current is a function of traction motor speed, torque delivered, and terminal voltage of the battery as described below during motoring and during regeneration:

$$\begin{matrix}\begin{matrix}{I}_{l o a d} = \frac{{T}_{m} \cdot {ω}_{r}}{{e}_{t b}} \cdot \frac{1.3558}{η} & \end{matrix} & ( Eq . 22 ) \\ {I}_{l o a d} = \frac{{T}_{m} \cdot {ω}_{r}}{{e}_{t b}} \cdot η \cdot 1.3358 & ( Eq . 23 )\end{matrix}$$

where e_{tb} is the battery terminal voltage, in volts; I_{load} is the inverter load current, in amps; ωᵣ is the rotor frequency, in rps; and η is the motor and inverter combined efficiency.

As shown in FIG. 6, the regenerative braking control strategy implemented by system 40 requires the following inputs: a brake switch signal (i.e., indicating if the braking system being activated), accelerator pedal position (e.g., percentage of pedal depression), engine clutch status (e.g., engaged/disengaged), motor clutch status (e.g., engaged/disengaged), motor speed, motor torque estimate, select mode signal (e.g., hybrid mode, electric mode, or engine only mode), Iq (motor torque current) actual, master cylinder pressure, and battery state-of-charge. The strategy produces the following outputs: an engine clutch request signal HY_CLU_REQ (i.e., engage/disengage), an Iq (motor torque current) request signal, and an engine throttle position signal HY_THR_DEM.

The select mode signal is a driver-controlled signal which indicates whether the driver is operating the vehicle in hybrid mode, motor only mode, or engine only mode. If the vehicle 10 is operating in engine only mode, regenerative braking will not occur and the HY_CLU_REQ output is permanently set to a logic value of zero, effective to prevent the engine clutch from disengaging. If the vehicle is operating in hybrid mode, the control system 40 determines if the vehicle is using the engine only, the motor only, or both the engine and the motor simultaneously. During any regenerative braking event (including simulated compression braking), the control system 40 disengages the engine clutch 20 (i.e., by setting the engine clutch request command HY_CLU_REQ to a logic value of one), effective to eliminate engine drag forces and allow only the motor to operate to slow the vehicle, thereby maximizing the amount of energy recovered.

If the vehicle is operating in motor only mode, or if a braking condition exists (e.g., the brake switch signal is high or has a logic value of 1) or if a gear shifting condition exists, then the engine throttle demand is over ridden and the engine is set to an idle speed through the HY_THR_DEM signal, and the engine clutch 20 is made to disengage through the HY_CLU_REQ signal.

Furthermore, when the vehicle is operating in motor only mode and the battery state-of-charge is high, the engine clutch 20 may be engaged during certain “idling conditions” (e.g., when the accelerator pedal position falls below a certain predetermined value), effective to induce “drag” or actual compression braking, thereby providing the driver with a consistent feel during “idling conditions” in all operational modes.

During braking events, the engine clutch 20 is disengaged, the engine is ramped to idle speed (by use of the HY_THR_DEM signal), and the transmission continues to shift allowing the transmission 18 to be in the proper gear when an engagement is requested.

The motor speed or angular velocity signal is received from a motor speed sensor and is converted from an angular speed value (e.g., in rotations per second) to a linear speed value (e.g., in meters per second). When the vehicle and/or motor speed falls below a predetermined low threshold speed, a linear ramp is applied to the requested regenerative brake torque (e.g., by use of the Iq request signal), thereby gradually “phasing out” or eliminating regenerative braking at low speeds when little or no energy can be recovered.

HY_THR_DEM is the throttle demand to the engine, and HY_CLU_REQ is a signal that causes the selective engagement/disengagement of the engine clutch 20. If HY_CLU_REQ is zero, the closing or engagement of the engine clutch 20 is under the control of the transmission controller 54 and the coordinated controller 44 does not override this signal. This allows the engine clutch 20 to engage/disengage under control of the transmission controller 54, if the engaging/disengaging the clutch 20 is desired by the transmission controller 54 (e.g., during gear shifts). The HY_CLU_REQ signal is set to one during regenerative braking events, which is effective to cause the coordinated controller 44 to override the transmission controller 54 and to open the engine clutch 20 during braking events, thereby maximizing the energy generated or recovered.

The Iq request output is the torque current request, in Amperes, to the traction motor or transaxle assembly 16. This current value is set within the positive and negative torque current envelope of the motor.

The control system 40 also determines the “motor torque available” as a function of motor speed. The control system 40 multiplies this maximum motor torque available as a function of speed and transaxle gear ratios to become the maximum motor torque available referred to the wheels signal (TmATwheelsMAX). If the absolute value of the motor torque command in Nm is less than the peak motor torque available as a function of motor angular velocity then the motor torque command that is communicated to the motor (e.g., through the Iq request signal) becomes the limited motor torque command. Otherwise, if the absolute value of the motor torque command is not less than the peak motor torque available then the limited motor torque command that is communicated to the motor becomes the peak motor torque available as a function of motor angular velocity. The limited motor torque signal is then multiplied by the retained sign value determined from the motor torque command, to become the total motor torque command referred to the motor (Iq request).

The regenerative braking strategy receives brake pressure commands as a signal (e.g., representing pressure in psi) from a pressure sensor in the master cylinder. This signal is eventually converted to electric brake torque (e.g., in Nm) that the motor will provide to assist the hydraulic brakes. The brake switch signal is also used to detect braking, as a system backup. If the brake switch and master cylinder sensor are “low” (e.g., equal a negative or zero logic value), the driver is not commanding braking. If a brake sensor command is present, then the driver is commanding braking.

Control system 40 also monitors accelerator pedal position, which represents the driver's accelerator command. If accelerator position is greater than some calibrated value or brake switch is “high” (e.g., equal to a positive or one logic value), then a “pedal condition” exists and the driver is asking for braking, acceleration or both. This “OR” condition is communicated through an inverter (e.g., a “NOT” gate) and constitutes a “no pedal” condition, which is used to command simulated compression braking (as previously described) to emulate engine drag forces in an internal combustion engine. The no pedal signal and brake switch are communicated through an “OR” gate to form a signal called braking logic which is high when the brakes are depressed or when simulated compression braking exists (i.e., when negative motor torque can be applied), thereby indicating that a regenerative braking condition exists.

The engine clutch status is high when the clutch is engaged and is low when the clutch is disengaged. The motor speed and motor torque estimate are also received, and are converted into “wheel power” from the motor in kWatts.

The Iq actual signal is used by the control system 40 to determine the Motor Torque Estimate (e.g., in Nm). The Iq actual signal is within the positive and negative torque current envelope of the motor and the motor torque estimate is within the positive and negative torque versus speed envelope of the motor (e.g., in Nm). The control system utilizes these values to determine the total motor torque command (e.g., in Nm), and to compute the Iq request (e.g., in amps).

Test Data and Simulation Results

The present invention was implemented within parallel hybrid electric vehicle and test data was taken. The vehicle was driven in engine only mode, motor only mode and hybrid mode while test data was taken.

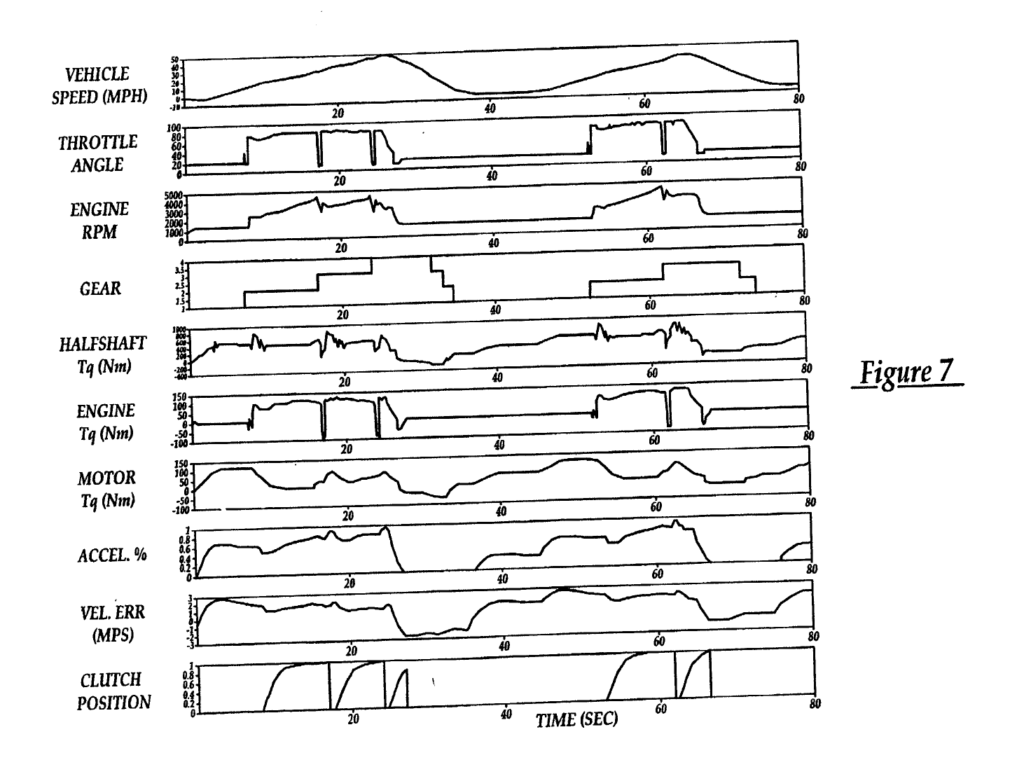

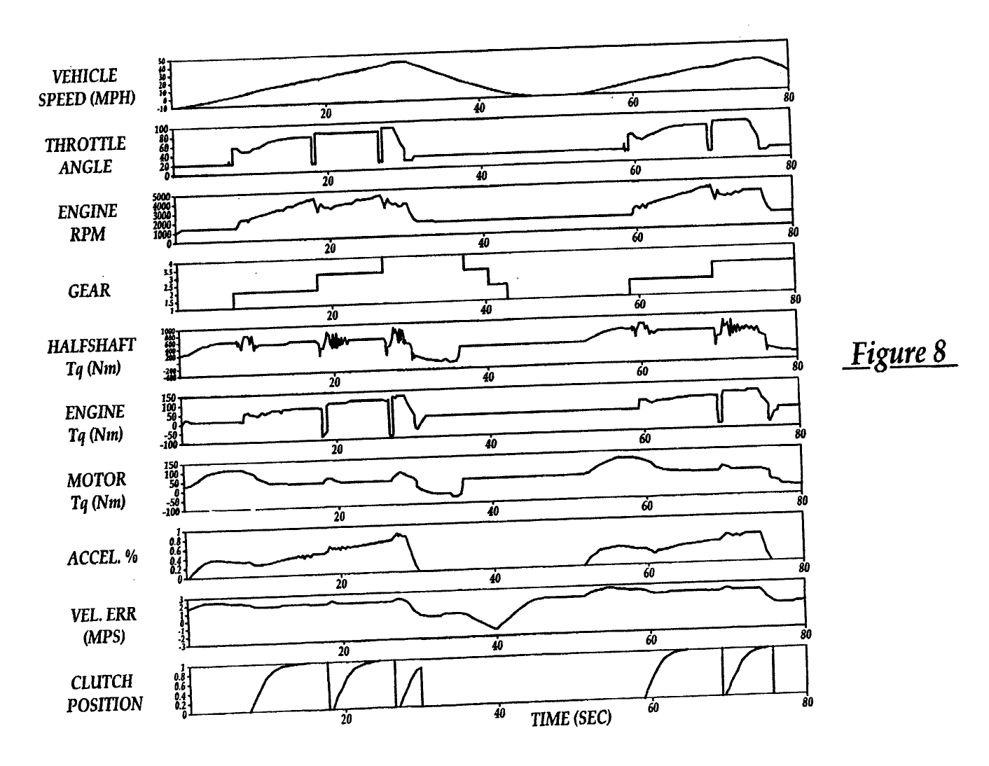

FIGS. 7 and 8 respectively illustrate simulations of a low acceleration/deceleration profile repeated on a 10% grade hybrid operation, and a low acceleration/deceleration profile repeated in hybrid operation. These simulations provided data which is illustrated in FIGS. 7 and 8 in the form of strip charts of vehicle velocity in mph, throttle angle in degrees, engine speed in rpm, gear number, halfshaft torque in Nm, engine torque in Nm, motor torque in Nm, accelerator position in per unit, velocity error between the command and vehicle in mps, and clutch position in per unit.

FIG. 7 illustrates a repeated acceleration/deceleration profile. During second gear, the motor does not assist the engine due to a less than 80% driver accelerator command. During third gear, motor assistance is necessary due to the driver commanding more than 80% throttle. During fourth gear, the driver continues to accelerate the vehicle, then begins to brake the vehicle.

During vehicle braking, the vehicle decelerates; the throttle angle is commanded to idle; the engine speed is driven to idle; the vehicle remains in fourth gear; the halfshaft torque becomes negative; the motor is operated as a generator and performs regenerative braking supplying negative torque to the drive wheels; the accelerator position is zero; the vehicle velocity error becomes negative; and the engine clutch disengages. As the vehicle decelerates, the transmission down shifts. As the vehicle speed approaches zero, the engine remains at idle, and first gear is obtained. The halfshaft torque and motor torque become zero, and the engine clutch remains open. The driver then commands acceleration at about 35 sec. The vehicle launches with motor only until second gear.

FIG. 8 illustrates that vehicle launch occurs in first gear using the traction motor. During second gear, occurring at approximately seven seconds, the throttle angle increases from idle to about 70 degrees; the engine speed ramps from idle to about 4000 rpm; the engine torque increases from zero to 60 Nm; the motor torque ramps from 50 Nm to zero; the driver accelerator command continues to increase; the vehicle continues to accelerate; the halfshaft torque follows the engine torque; the vehicle velocity error goes to zero; and the clutch closes. Third gear operates as second gear. During the gear change from second to third the motor torque rises to fill in during the gear shift.

During fourth gear operation, the driver stops commanding vehicle acceleration; the throttle angle decreases from 90 degrees to idle; the engine speed decreases from about 3000 rpm to idle; the halfshaft torque shows a transition between positive torque to negative torque provided by regenerative braking; the engine produces positive torque, transitions to negative brake torque, and then to idle torque; the motor transitions from positive tractive torque to regenerative brake torque; the velocity error becomes negative; the clutch does not fully engage, then disengages. When the engine provides negative brake torque during the transition from positive torque to negative torque, the clutch is disengaged so that regenerative brake torque usage is optimized. During the beginning of fourth gear operation, the driver is commanding over 80% throttle momentarily. During this time, the motor, after providing fill in torque during the gear shift from three to four, provides torque boost.

The vehicle decelerates to a stop; the throttle angle remains at idle; the vehicle speed remains at idle; the gear change from four to one even though the clutch is disengaged such that the gear would be appropriate if the driver suddenly commanded acceleration; the halfshaft torque becomes zero, when regenerative brake torque can no longer be collected, leaving the hydraulic brakes to continue the task of vehicle deceleration alone; the engine torque is zero the motor torque goes to zero when regenerative braking is completed; the accelerator pedal remains untouched by the driver; the vehicle velocity error goes to zero; and the clutch remains disengaged. The vehicle again accelerates upon driver request in a similar manner.

It is understood that the invention is not limited by the exact construction or method illustrated and described above, but that various changes and/or modifications may be made without departing from the spirit and/or the scope of the inventions.

1. A braking system for use within a hybrid electric vehicle of the type having a driveline which selectively and rotatably drives a pair of wheels, said braking system comprising:
an engine which is adapted to selectively provide a first torque to said driveline;
a first clutch which is adapted to selectively disconnect said engine from said driveline;
a transaxle assembly which is adapted to selectively provide a negative torque to said driveline effective to recover energy during certain braking events; and
a control system which controls said first clutch and which selectively disengages said first clutch during said certain braking events, effective to disconnect said engine from said driveline during said certain braking events, thereby increasing said recovered energy.

2. The braking system of claim 1 wherein said vehicle further includes an accelerator pedal, and wherein said control system is further effective to selectively disengage said first clutch during based upon a position of said accelerator pedal and to cause said transaxle assembly to provide a simulated compression braking force to said driveline based upon said position of said accelerator pedal, effective to simulate engine drag and to recover energy.

3. The braking system of claim 1 further comprising:
a hydraulic braking system which selectively provides a friction braking force to said vehicle; and
wherein said control system is further effective to control said regenerative torque and said friction braking force based upon at least one vehicle attribute.

4. The braking system of claim 3 wherein said transaxle assembly comprises a motor/generator, and wherein said at least one vehicle attribute comprises a speed of said motor/generator.

5. The braking system of claim 4 wherein said control system is effective to reduce said regenerative braking force as said speed of said vehicle decreases below a predetermined value.

6. The braking system of claim 5 wherein said regenerative braking force is reduced linearly as said speed of said vehicle decreases below said predetermined value.

7. The braking system of claim 3 wherein said at least one vehicle attribute comprises a master cylinder pressure.

8. The braking system of claim 3 wherein said at least one vehicle attribute further comprises a state-of-charge of said battery.

9. A hybrid electric vehicle comprising:
a pair of wheels;
a driveline which selectively and rotatably drives said pair of wheels;
an engine which is selectively and operatively coupled to and which selectively provides a first torque to said driveline;
a first clutch which selectively connects and disconnects said engine from said driveline;
a motor/generator which selectively provides an amount of negative torque to said driveline effective to recover energy during certain braking events;
at least one sensor which measures at least one vehicle attribute; and
a control system which is communicatively coupled to said at least one sensor to said first clutch and to said motor/generator, and which is effective to selectively disengage said first clutch during said certain braking events, thereby disconnecting said engine from said driveline during said certain braking events, and to control said amount of negative torque based upon said at least one vehicle attribute.

10. The hybrid electric vehicle of claim 9 wherein said at least one sensor comprises a pressure sensor, and wherein said at least one vehicle attribute comprises a master cylinder pressure.

11. The hybrid electric vehicle of claim 10 wherein said at least one sensor comprises an accelerator pedal position sensor, and wherein said at least one vehicle attribute comprises an accelerator pedal position.

12. The hybrid electric vehicle of claim 11 wherein said control system is further effective to selectively disengage said first clutch during based upon said accelerator pedal position and to cause said motor/generator assembly to provide a simulated compression braking force to said driveline based upon said accelerator pedal position, effective to simulate engine drag and to recover energy.

13. The hybrid electric vehicle of claim 10 further comprising:
at least one battery which selectively receives said recovered energy from said motor/generator; and
wherein said controls system is further effective to control said amount of negative torque based upon said a state-of-charge of said at least one battery.

14. A method of providing regenerative braking within a vehicle including an engine and a transaxle assembly which are selectively connected to a driveline, said method comprising the steps of:
sensing a braking event;
causing said transaxle to provide a regenerative braking torque to said driveline, effective to generate an amount of energy; and
selectively disconnecting said engine from said driveline during said braking event, effective to increase the amount of energy generated during said braking eve nt.

15. The method of claim 14 further comprising the steps of:
sensing an accelerator position; and
selectively causing said transaxle assembly to provide a regenerative braking torque based upon said accelerator position when said vehicle is operating in a motor only mode, said regenerative braking torque having a value effective to simulate an engine compression braking force.

16. The method of claim 15 further comprising the steps of:
selectively disconnecting said engine from said driveline based upon said accelerator position when said vehicle is operating in a hybrid drive mode, and
causing said transaxle assembly to provide a regenerative braking torque having a value effective to simulate an engine compression braking force.

17. The method of claim 16 wherein said vehicle further includes a battery, said method further comprising the steps of:
determining a state-of-charge of said battery; and
performing compression braking with said engine when said state-of-charge of said battery is full.

18. The method of claim 14 further comprising the steps of:
sensing a master cylinder pressure; and
controlling said regenerative braking torque based upon said master cylinder pressure.

19. The method of claim 18 wherein said regenerative braking torque is reduced as said master cylinder pressure increases, after said master cylinder pressure exceeds a predetermined value.
